(19) United States
(12) Patent Application Publication
(10) Pub. No.: US 2025/0018809 A1
(43) Pub. Date: Jan. 16, 2025

(54) Charging Apparatus

(71) Applicant: Autel Digital Power Co., Ltd., Shenzhen (CN)

(72) Inventors: Yunfeng XU, Shenzhen (CN); Yaqiao WANG, Shenzhen (CN)

(73) Assignee: Autel Digital Power Co., Ltd., Shenzhen, GD (CN)

(21) Appl. No.: 18/712,252

(22) PCT Filed: Nov. 1, 2022
(86) PCT No.: PCT/CN2022/129051

§ 371 Date: May 22, 2024

(30) Foreign Application Priority Data
Nov. 24, 2021 (CN) 202122922510.2

(51) Int. Cl. B60L 53/16; B60L 53/31; B60L 53/60

(52) U.S. Cl. CPC B60L 53/16; B60L 53/31; B60L 53/60

(57) ABSTRACT

A charging apparatus, includes a charging pile and a charging gun. The charging pile is provided with a slot, and a reader is provided in the slot; a charging gun is connected to the charging pile, the charging gun includes a gun head, the gun head is used for plugging into a slot, and the charging gun is provided with at least two electronic tags; in a state where the gun head is just plugged into the slot, the reader just identifies an electronic tag, and in a state where the gun head is completely plugged into the slot, the reader just identifies another electronic tag; therefore, the charging apparatus can distinguish whether the charging gun corresponds to returning a gun and whether the charging gun is returned in place.

The present application claims priority to the Chinese patent application No. 202122922510.2 entitled “charging apparatus” filed on Nov. 24, 2021, to the China National Intellectual Property Administration, the entire contents of which are incorporated herein by reference.

### TECHNICAL FIELD

The present application relates to the technical field of charging piles, and in particular to a charging apparatus.

### BACKGROUND OF THE INVENTION

With the rapid development of electrical energy, new energy automobiles with low cost and little environmental pollution have been favored by people. A charging pile is the power base for new energy automobiles to provide power endurance. The charging pile is generally installed in public buildings, parking lots, or charging stations, and can charge various types of electric automobiles according to different voltage levels.

The charging pile usually charges an electric automobile by means of a charging gun, and the gun returning detection function of the charging pile improves the safety and intelligence of the charging pile. The traditional gun returning detection is usually completed by means of an infrared or ultrasonic transceiver module, and the module automatically sends out infrared light, and then judges whether a charging gun is plugged into a gun position according to a reflected signal. However, such a scheme has limitations in that it is impossible to identify whether an obstacle is plugged into a slot, and it is also difficult to identify whether other charging guns are plugged into a slot that does not correspond thereto; therefore, there is an urgent need for a more accurate identification scheme.

### SUMMARY OF THE INVENTION

The present disclosure proposes a charging apparatus to solve the technical problem that it is difficult to accurately identify the gun returning state of a charging gun.

The technical scheme of the present disclosure is achieved as follows:
an embodiment of the present disclosure provides a charging apparatus including:
   a charging pile provided with a slot, wherein a reader is provided in the slot; and
   a charging gun connected to the charging pile, wherein the charging gun comprises a gun head, the gun head is used for plugging into the slot, and the gun head is provided with at least two electronic tags,
   wherein the reader just identifies one of the electronic tags in a state where the gun head is just plugged into the slot, and just identifies another electronic tag in a state where the gun head is completely plugged into the slot.

In one embodiment, the electronic tag comprises a first tag and a second tag;
the first tag and the second tag are respectively provided at two ends of the gun head, and the reader is provided at an entrance of the slot;
the reader just identifies the first tag when the gun head enters the entrance, and just identifies the second tag in a state where the gun head is completely plugged into the slot.

The reader just identifies the first tag when the gun head enters the entrance, and just identifies the second tag in a state where the gun head is completely plugged into the slot. Therefore, the charging apparatus can distinguish two states of “no gun returned” and “the returned gun not being in place”.

In one embodiment, the length of the gun head is adapted to the depth of the slot, and the first tag and the second tag are arranged along a length direction of the gun head.

The gun head is plugged into the slot in one direction, and the first tag and the second tag are arranged along the length direction of the gun head to facilitate the reader to identify the two above-mentioned electronic tags; when the user plugs the gun head into the slot in the depth direction of the slot, the reader can first identify the first tag and then identify the second tag.

In one embodiment, the slot further comprises a positioning opening, an inner wall of the positioning opening is smoothly connected to the inner wall of the entrance, and a cross section of the positioning opening is gradually reduced in the depth direction of the slot.

The cross section of the positioning opening is set to gradually decrease to facilitate the gun head to find the entrance of the slot.

In one embodiment, multiple readers are provided, and multiple readers correspond to the electronic tags in a one-to-one manner; in the state where the gun head is completely plugged into the slot, each of the readers just identifies one electronic tag corresponding thereto.

Multiple readers perform identification at the same time to improve the accuracy of the gun returning detection.

In one embodiment, the charging gun is plural, the charging pile comprises multiple slots, and each of the multiple charging guns corresponds to one slot.

In one embodiment, the charging gun further comprises a first indicator lamp and a second indicator lamp, wherein both the first indicator lamp and the second indicator lamp are exposed outside the slot in a state where the charging gun is plugged into a plugged-in state;
the first indicator lamp is used for displaying that the charging gun is plugged into a slot corresponding thereto;
the second indicator lamp is used for displaying that the charging gun is completely plugged into a slot corresponding thereto.

In one embodiment, the charging gun further comprises a third indicator lamp for displaying that the charging gun is in a charging state.

The above-mentioned three indicator lamps are provided to facilitate the charging apparatus to prompt the user correspondingly according to the gun returning state.

In one embodiment, the charging gun further comprises a gun body and a handle;
one end of the gun body is connected to the gun head, and the other end is connected to the handle, wherein an insulating rubber pad is provided on the handle.

The handle is provided to facilitate the user to pick up the charging gun, and the insulating rubber pad is provided to improve the safety of using the charging gun.

In one embodiment, the electronic tag is a radio frequency electronic tag and the reader is a radio frequency reader. The reader can be selected to be an RFID reader so that with the close-range identification feature of the RFID, the charging apparatus can accurately identify the gun returning state.

The charging apparatus of the present disclosure has the following beneficial effects over the prior art.
in the charging apparatus of the embodiments of the present disclosure, at least two electronic tags are provided on the gun head of the charging gun; in a state where the gun head is just plugged into the slot, the reader just identifies one electronic tag; in a state where the gun head is completely plugged into the slot, the reader just identifies another electronic tag, so that the charging apparatus can distinguish whether the charging gun corresponds to returning a gun and whether the charging gun is returned in place, and can accurately identify a state difference between a user who does not return a gun and a user who does not return a gun in place, so as to prevent the user from erroneously returning a gun, and improve the accuracy of the gun returning detection of the charging apparatus.

### BRIEF DESCRIPTION OF DRAWINGS

FIG. 1 is a schematic structural diagram of a charging apparatus according to an embodiment of the present disclosure;

FIG. 2 is a schematic structural diagram of a charging apparatus according to an embodiment of the present disclosure;

FIG. 3 is a schematic diagram of a charging gun completely plugged into a slot according to an embodiment of the present disclosure;

FIG. 4 is a schematic flow diagram of a charging gun plugged into a slot according to an embodiment of the present disclosure:

FIG. 5 is a schematic structural diagram of a charging apparatus according to an embodiment of the present disclosure;

FIG. 6 is a schematic diagram of a charging gun plugged into a slot according to an embodiment of the present disclosure.

### DESCRIPTION OF REFERENCE NUMERALS

10, charging pile; 11, slot; 111, positioning opening; 12, reader;
20, charging gun; 21, gun head; 22, gun body; 23, handle; 24, electronic tag; 241, first tag; 242, second tag; and
30, cable.

### DETAILED DESCRIPTION OF THE INVENTION

In order to make the present disclosure readily understood, a more detailed description of the present disclosure will be rendered with reference to the appended drawings and specific embodiments. It should be noted that when an element is referred to as being “secured” to another element, it can be directly on the other element or one or more intervening elements may be present therebetween. When one element is referred to as being “connected” to another element, it can be directly connected to the other element or one or more intervening elements may be present therebetween.

Unless defined otherwise, all technical and scientific terms used in the specification have the same meaning as commonly understood by one of ordinary skill in the art to which the present disclosure belongs. In the description, the terminology used in the description of the present disclosure is for the purpose of describing specific embodiments only and is not intended to limit the present disclosure.

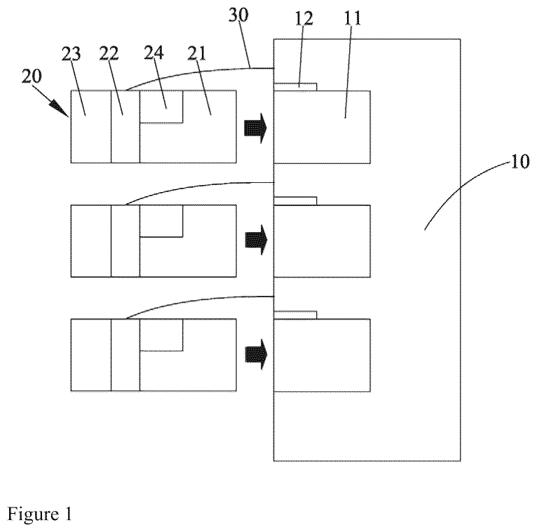

Embodiments of the present disclosure provide a charging apparatus, referring to FIG. 1, including a charging pile 10 and a charging gun 20.

The charging pile 10 can be electrically connected to a mains supply, and the charging gun 20 can be electrically connected to the charging pile 10 via a cable 30. The charging pile 10 is used for providing electric power to the charging gun 20, and the charging gun 20 can directly charge the electric automobile.

The charging pile 10 is provided thereon with a slot 11. Generally, the charging pile 10 is a box body vertically arranged on the ground, the depth direction of the slot 11 has a certain inclination angle with the vertical direction of the charging pile 10, and the depth direction of the slot 11 is inclined downwards, or, as shown in FIG. 1, the slot 11 is directly arranged in a horizontal state. The charging gun 20 can be selected to be a handheld charging gun 20. Specifically, referring to FIG. 1, the charging gun 20 comprises a gun head 21, a gun body 22, and a handle 23. One end of the gun body 22 is connected to the gun head 21, and the other end is connected to the handle 23; when the charging gun 20 is plugged into the slot 11, the handle 23 is exposed outside the slot 11, and a user can directly pick up the charging gun 20 via the handle 23. In order to improve the safety of using the charging gun 20, an insulating rubber pad (not shown in the drawings) may be provided on the handle 23, and an anti-slip pattern may also be provided on the insulating rubber pad so that a user can hold the charging gun 20 in hand. When the charging gun 20 is not in use, the gun head 21 is directly plugged into the slot 11 of the charging pile 10 so as to protect the charging gun 20; when the charging gun 20 is in use, the gun head 21 can be directly plugged into a charging slot of an external electric automobile to charge the electric automobile.

In order to improve charging efficiency and reduce costs, generally, referring to FIG. 1, multiple slots 11 are provided on the charging pile 10, and accordingly, each slot 11 is respectively provided with one charging gun 20 correspondingly; after the charging of the electric automobile by the charging gun 20 is completed, the charging gun 20 needs to be returned to a gun homing position so as to completely plug the charging gun 20 into the slot 11 of the charging pile 10; this requires a gun returning detection of the charging gun 20 to ensure that the charging gun 20 is correctly plugged into the slot 11.

In one embodiment, an electronic tag 24 is provided on a gun head 21 of the charging gun 20, and the slot 11 is provided therein with a reader 12. The reader 12 is used for identifying the electronic tag 24 on the gun head 21, and the reader 12 comprises preset information; after reading and identifying the information of the electronic tag 24, the information about the electronic tag 24 can be compared with the preset information so as to judge whether the information about the electronic tag 24 matches the preset information.

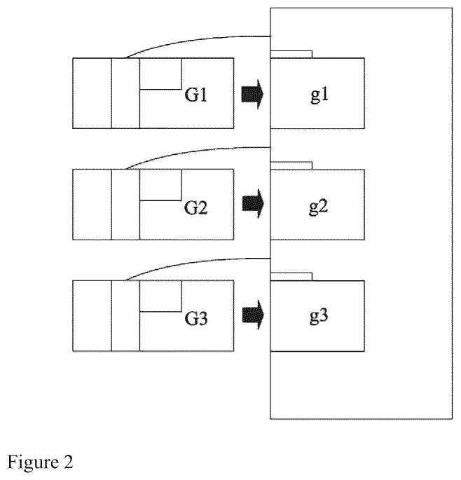

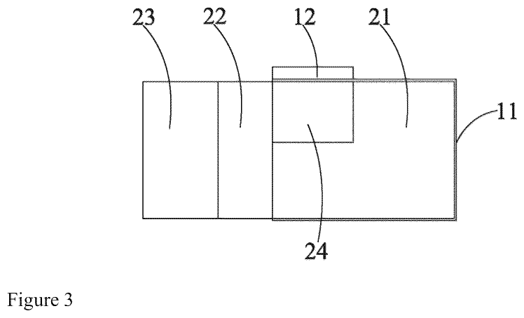

Specifically, referring to FIG. 2, the charging apparatus comprises three charging guns G1, G2, and G3, and three slots g1, g2, and g3. The charging gun G1 corresponds to the slot g1, the charging gun G2 corresponds to the slot g2, and the charging gun G3 corresponds to the slot g3; when the charging apparatus simultaneously charges two vehicles, after the user completes charging with the charging gun G1, the charging gun G1 is plugged into the slot g2, the reader in the slot g2 identifies that the information of the electronic tag and the preset information of the reader do not match, and the charging apparatus will issue a warning of “not correspondingly returning the gun”. Likewise, when an obstacle is plugged into the slot 11, the reader 12 cannot identify the obstacle and may also issue a warning of “not correspondingly returning the gun” to let the user check whether the slot 11 is blocked. Reference is now made to FIG. 3, which shows a schematic diagram when a gun head 21 is completely plugged into a slot 11.

In one embodiment, a detection apparatus (not shown in the drawing) may also be provided in the slot 11 for detecting whether the slot 11 is blocked by an obstacle. For example, providing an infrared transmitter and an infrared receiver such that when the slot 11 is blocked by an obstacle, the infrared ray emitted by the infrared transmitter is blocked so that the infrared receiver cannot perform identification, and the corresponding electronic tag 24 is not identified by the reader 12, and then the charging apparatus issues a warning that “The slot 11 is blocked by an obstacle”.

When a user plugs the gun head 21 into the slot 11, the reader 12 does not identify the electronic tag 24 on the gun head 21 because the user does not plug the gun head 21 into place (the gun head 21 is not completely plugged into the slot 11); at this time, the charging apparatus still displays “no gun returned”, and the charging apparatus cannot judge whether the charging gun 20 is in the state of “the returned gun not being in place” or “no gun returned”.

Therefore, in one embodiment, at least two electronic tags 24 are provided on the charging gun 20; when the gun head 21 is just plugged into the slot 11, the reader 12 just identifies one electronic tag 24, and compares the information about the electronic tag 24 with preset information; when the two pieces of information match, the charging apparatus displays “the returned gun not being in place”; when the gun head 21 is completely plugged into the slot 11, the reader 12 just identifies another electronic tag 24, and compares the information about the electronic tag 24 with preset information; when the two pieces of information match, the charging apparatus displays that “The gun has been returned”.

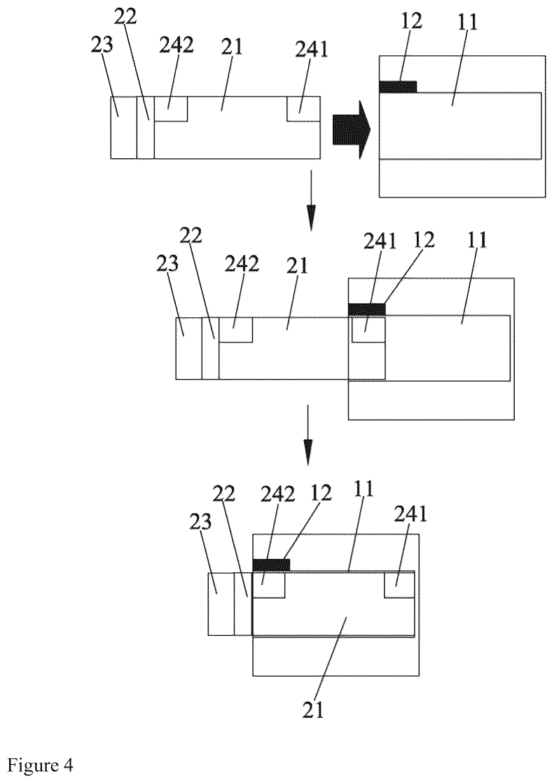

Specifically, referring to FIG. 4, in order to facilitate understanding, the electronic tag 24 comprises a first tag 241 and a second tag 242. The first tag 241 comprises information A, and the second tag 242 comprises information B; after the user plugs the gun head 21 into the slot 11, since the gun head 21 is not plugged in place, the charging apparatus only identifies information A, and does not identify the information B; at this moment, the charging apparatus issues a warning of “the returned gun not being in place” so as to prompt the user to adjust the charging gun 20; when the charging gun 20 is plugged in place, the reader 12 just identifies the information B on the second tag 242, at which time the charging apparatus issues a prompt that “The gun has been returned”. Similarly, when the charging apparatus charges two vehicles at the same time, after the user finishes charging with the charging gun 20G1, the plug of the charging gun 20G1 is plugged into the slot 11g2, the reader 12 in the slot 1192 detects that the information about the electronic tag 24 does not match the preset information about the reader 12, and the charging apparatus issues a warning of “not correspondingly returning the gun”.

It needs to be noted that, in order to facilitate the reader 12 to accurately detect the first tag 241 and the second tag 242, and enable the reader 12 to identify the first tag 241 and the second tag 242 at the first time, the first tag 241 and the second tag 242 can be respectively provided at two ends of the gun head 21, and the reader 12 can be provided at the entrance of the slot 11; when the gun head 21 enters the entrance, the reader 12 just identifies the first tag 241; in the state where the gun head 21 is completely plugged into the slot 11, the reader 12 just identifies the second tag 242, and thus the charging apparatus can distinguish two states of “no gun returned” and “the returned gun not being in place”.

In one embodiment, the length of the gun head 21 is adapted to the depth of the slot 11; when the gun head 21 is completely plugged into the slot 11, both the gun body 22 and the handle 23 of the charging gun 20 are exposed outside the slot 11; generally, the gun head 21 is plugged into the slot 11 in one direction; in order to facilitate the reader 12 to identify the above-mentioned two electronic tags 24, the first tag 241 and the second tag 242 can be arranged along the length direction of the gun head 21; when the user plugs the gun head 21 into the slot 11 in the depth direction of the slot 11, the reader 12 can first identify the first tag 241 and then identify the second tag 242. It could be understood that a groove can also be provided on the gun head 21. The groove is provided along the length direction of the gun head 21, a protrusion corresponding to the groove is provided in the slot 11, and when the gun head 21 is plugged into the slot 11, the protrusion extends into the groove so as to limit the gun head 21 and prevent the gun head 21 from rotating in the slot 11.

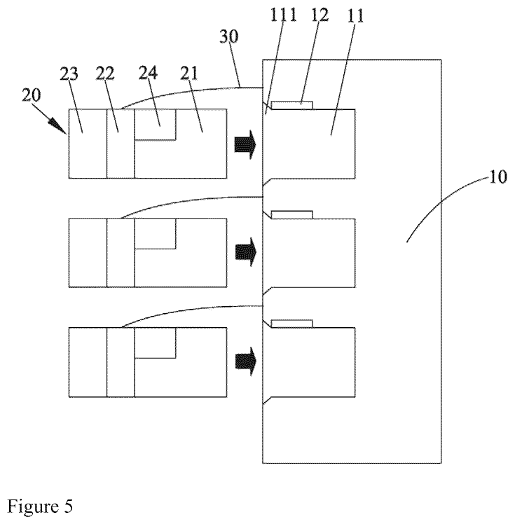

In one embodiment, in order to facilitate the gun head 21 to find the entrance of the slot 11, referring to FIG. 5, the slot 11 further comprises a positioning opening 111, the inner wall of the positioning opening 111 is smoothly connected to the inner wall of the entrance of the slot 11, and the cross section of the positioning opening 111 gradually decreases along the depth direction of the slot 11; it could be understood that the opening of the positioning opening 111 is larger than the entrance of the slot 11, and the positioning opening 111 can be provided as a tapered shape with the outer opening having the largest cross section so as to facilitate the gun head 21 to locate and find the entrance of the slot 11.

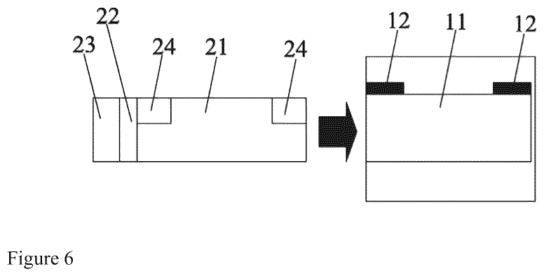

In one embodiment, in order to enable the reader 12 to accurately identify with the reader 12 and ensure that the charging gun 20 is accurately returned in place, referring to FIG. 6, the reader 12 may be provided to be multiple. Multiple readers 12 correspond to the electronic tag 24 in a one-to-one correspondence. In the state where the gun head 21 is completely plugged into the slot 11, each reader 12 just identifies one electronic tag 24 corresponding thereto. Multiple readers 12 perform identification at the same time to improve the accuracy of the gun returning detection.

In one embodiment, in order to prompt a user of “the returned gun being in place”, “not correspondingly returning the gun”, etc. the charging gun 20 further comprises a first indicator lamp and a second indicator lamp. Each first indicator lamp can be provided on the gun body 22 (each indicator lamp is shown in the drawing), that is to say, in the state where the charging gun 20 is plugged into the plugged-in state, both the first indicator lamp and the second indicator lamp are exposed outside the slot 11; the first indicator lamp is used for displaying that the charging gun 20 is plugged into the slot 11 corresponding thereto; the second indicator lamp is used for indicating that the charging gun 20 is completely plugged into the slot 11 corresponding thereto.

Specifically, after the reader 12 identifies the information A of the first tag 241, the information A matches with the first preset information of the reader 12, and at this time, the first indicator lamp lights up; when the reader 12 identifies the information B of the second tag 242, the information B matches the second preset information of the reader 12, and at this time, the second indicator lamp lights up. Similarly, a third indicator lamp may also be provided on the charging gun 20 to display that the charging gun 20 is in a charging state. It could be understood that the above-mentioned indicator lamp can also be replaced by a display screen for displaying a gun returning state at this time, and can also be replaced by a voice announcer to directly announce the corresponding gun returning state via the voice announcer.

It needs to be noted that the above-mentioned electronic tag 24 can be selected to be a radio frequency electronic tag 24, and the above-mentioned reader 12 can be selected to be a radio frequency reader 12, namely, an RFID reader 12. With the close-range identification feature of the RFID, the charging apparatus of this embodiment can accurately identify the gun returning state.

In the charging apparatus of the embodiments of the present disclosure, at least two electronic tags 24 are provided on the gun head 21 of the charging gun 20; in a state where the gun head 21 is just plugged into the slot 11, the reader 12 just identifies one electronic tag 24; in a state where the gun head 21 is completely plugged into the slot 11, the reader 12 just identifies another electronic tag 24, so that the charging apparatus can distinguish whether the charging gun 20 corresponds to returning a gun and whether the charging gun 20 is returned in place, and can accurately identify a state difference between a user who does not return a gun and a user who does not return a gun in place, so as to prevent the user from erroneously returning a gun, and improve the accuracy of the gun returning detection of the charging apparatus.

It needs to be noted that the description of the present disclosure and the accompanying drawings set forth preferred embodiments of the present disclosure, however, the present disclosure may be implemented in many different forms and is not limited to the embodiments set forth herein; these embodiments do not serve as additional restrictions on the contents of the present disclosure; the purpose of providing these embodiments is to make the understanding of the contents of the present disclosure more thorough and comprehensive. In addition, the above-mentioned technical features are further combined with each other to form various embodiments which are not listed above, and all are considered to be within the scope recorded in the description of the present disclosure; further, for those of ordinary skills in the art, they can make improvements or changes according to the above description, and all such improvements and changes should fall within the scope of protection of the appended claims of the present disclosure.

1. A charging apparatus, comprising:
a charging pile provided with a slot, wherein a reader is provided in the slot; and
a charging gun connected to the charging pile, wherein the charging gun comprises a gun head, the gun head is used for plugging into the slot, and the gun head is provided with at least two electronic tags;
wherein the reader identifies one of the electronic tags in a state where the gun head is just plugged into the slot, and identifies another one of the electronic tags in a state where the gun head is completely plugged into the slot.

2. The charging apparatus according to claim 1, wherein the at least two electronic tags comprise a first tag and a second tag;
the first tag and the second tag are respectively provided at two ends of the gun head, and the reader is provided at an entrance of the slot;
the reader just identifies the first tag when the gun head enters the entrance, and just identifies the second tag in the state where the gun head is completely plugged into the slot.

3. The charging apparatus according to claim 2, wherein a length of the gun head is adapted to a depth of the slot, and the first tag and the second tag are arranged along a length direction of the gun head.

4. The charging apparatus according to claim 3, wherein the slot further comprises a positioning opening, an inner wall of the positioning opening is smoothly connected to the inner wall of the entrance, and a cross section of the positioning opening is gradually reduced in the depth direction of the slot.

5. The charging apparatus according to claim 1, wherein multiple said readers are provided, and the multiple said readers correspond to the at least two electronic tags in a one-to-one manner; in the state where the gun head is completely plugged into the slot, each of the readers just identifies one of the at least two electronic tags corresponding thereto.

6. The charging apparatus according to claim 1, wherein multiple said charging guns are provided, the charging pile comprises multiple said slots, and each of the multiple said charging guns corresponds to one of the multiple said slots.

7. The charging apparatus according to claim 6, wherein each of the multiple said charging guns further comprises a first indicator lamp and a second indicator lamp, wherein both the first indicator lamp and the second indicator lamp are exposed outside the slot when the gun head is plugged into the slot
the first indicator lamp is used for displaying that the charging gun is plugged into the slot corresponding thereto; and
the second indicator lamp is used for displaying that the charging gun is completely plugged into the slot corresponding thereto.

8. The charging apparatus according to claim 7, wherein the charging gun further comprises a third indicator lamp for displaying that the charging gun is in a charging state.

9. The charging apparatus according to claim 1, wherein the charging gun further comprises a gun body and a handle;
one end of the gun body is connected to the gun head, and the other end is connected to the handle, wherein an insulating rubber pad is provided on the handle.

10. The charging apparatus according to claim 1,
wherein the at least two electronic are radio frequency electronic tags and the reader is a radio frequency reader.
